(19) United States
(12) Patent Application Publication
(10) Pub. No.: US 2019/0006866 A1
(43) Pub. Date: Jan. 3, 2019

(54) MILLIPORE VAPORIZER ASSEMBLY AND ELECTRONIC CIGARETTES HAVING THE SAME

(71) Applicant: SHENZHEN KANGER TECHNOLOGY CO., LTD., SHENZHEN (CN)

(72) Inventor: XIAOCHUN ZHU, SHENZHEN (CN)

(73) Assignee: SHENZHEN KANGER TECHNOLOGY CO., LTD., SHENZHEN (CN)

(21) Appl. No.: 15/638,528

(22) Filed: Jun. 30, 2017

(30) Foreign Application Priority Data
Jun. 29, 2017 (CN) 201710515274.8

(51) Int. Cl. H02J 7/00; A24F 47/00; H05B 1/02

(52) U.S. Cl. CPC H02J 7/0057; H02J 7/0054; B65D 25/005; H05B 1/0291; H05B 1/0297; A24F 47/008

(57) ABSTRACT

Present disclosure relates to a millipore vaporizer assembly and electronic cigarettes having the millipore vaporizer assembly. In certain embodiments, the millipore vaporizer assembly includes: a mouthpiece assembly for a user to enjoy vaporized E-liquid, an E-liquid storage tank assembly for storing E-liquid, and a millipore vaporizer element for generating the vaporized E-liquid. The millipore vaporizer element is positioned on a millipore vaporizer element support, and the millipore vaporizer element is used for receiving and heating the E-liquid from the E-liquid storage tank assembly to generate the vaporized E-liquid. The millipore vaporizer element has a first electric terminal and a second electric terminal. When the user connects the first electric terminal and the second electric terminal to an electrical power supply assembly, the millipore vaporizer element receives the E-liquid from the E-liquid storage tank assembly and heats the E-liquid received through the millipore vaporizer element to generate the vaporized E-liquid.

### FIELD

The present disclosure generally relates to the field of electronic cigarettes, and more particularly to millipore vaporizer assembly, electronic cigarettes having the millipore vaporizer assembly, and methods of using the electronic cigarettes having the millipore vaporizer assembly.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is well known that smoking cigarette is harmful to smoker's health. The active ingredient in a cigarette is mainly nicotine. During smoking, nicotine, along with tar aerosol droplets produced in the cigarette burning, are breathed into the alveolus and absorbed quickly by the smoker. Once nicotine is absorbed into the blood of the smoker, nicotine then produces its effect on the receptors of the smoker's central nervous system, causing the smoker relax and enjoy an inebriety similar to that produced by an exhilarant.

The electronic cigarette is sometimes referred as electronic vaporing device, personal vaporizer (PV), or electronic nicotine delivery system (ENDS). It is a battery-powered device which simulates tobacco smoking. It generally uses a heating element that vaporizes a liquid solution (e-liquid). Some solutions contain a mixture of nicotine and a variety of flavorings, while others release a flavored vapor without nicotine. Many are designed to simulate smoking experience, such as cigarette smoking or cigar smoking. Some of them are made with similar appearance, while others are made considerably different in appearance.

Conventional electronic cigarettes use cotton fibers, polypropylene fibers, terylene fibers, and/or nylon fibers, as E-liquid media around one or more heating elements. These fibers may be burnt, and such burning leaves certain burnt smell in the vaporized E-liquid for users to inhale. It is desirable that the electronic cigarette has an ability to provide vaporized E-liquid without burning smell.

Therefore, an unaddressed need exists in the art to address the aforementioned deficiencies and inadequacies.

### SUMMARY

In one aspect, the present disclosure relates to a millipore vaporizer assembly. In certain embodiments, the millipore vaporizer assembly includes: a mouthpiece assembly for a user to enjoy vaporized E-liquid, an E-liquid storage tank assembly for storing E-liquid, and a millipore vaporizer element for generating the vaporized E-liquid. The millipore vaporizer element is positioned on a millipore vaporizer element support, and the millipore vaporizer element is used for receiving and heating the E-liquid from the E-liquid storage tank assembly to generate the vaporized E-liquid. The millipore vaporizer element has a first electric terminal and a second electric terminal. When the user connects the first electric terminal and the second electric terminal to an electrical power supply assembly, the millipore vaporizer element receives the E-liquid from the E-liquid storage tank assembly and heats the E-liquid received through the millipore vaporizer element to generate the vaporized E-liquid.

In another aspect, the present disclosure relates to an electronic cigarette. In certain embodiments, the electronic cigarette includes a millipore vaporizer assembly and an electrical power supply assembly. The millipore vaporizer assembly may include: a mouthpiece assembly for a user to enjoy vaporized E-liquid, an E-liquid storage tank assembly for storing E-liquid, and a millipore vaporizer element. The millipore vaporizer element is positioned on a millipore vaporizer element support, and the millipore vaporizer element is used for receiving and heating the E-liquid from the E-liquid storage tank assembly to generate the vaporized E-liquid. The millipore vaporizer element has a first electric terminal and a second electric terminal. When the user connects the first electric terminal and the second electric terminal to the electrical power supply assembly, the millipore vaporizer element receives the E-liquid from the E-liquid storage tank assembly and heats the E-liquid received through the millipore vaporizer element to generate the vaporized E-liquid.

In yet another aspect, the present disclosure relates to method of using an electronic cigarette having a millipore vaporizer assembly. In certain embodiments, the method includes: positioning, by a user, the electronic cigarette upside down, and disconnecting an electrical power supply assembly from the electronic cigarette; and removing a refilling opening plug from the electronic cigarette, and filling, by the user, E-liquid into an E-liquid storage tank assembly. The method may also include: connecting, by the user, the electrical power supply assembly to the electronic cigarette and positioning the electronic cigarette mouthpiece side up to allow the E-liquid in the E-liquid storage tank assembly to soak into a millipore vaporizer element, turning, by the user, on the electrical power supply assembly to provide electrical power to the millipore vaporizer assembly, and sucking E-liquid vapor from the millipore vaporizer assembly through a mouthpiece assembly. Air outside of the electronic cigarette enters the millipore vaporizer assembly through certain number of air intake openings defined and evenly distributed outside of the mouthpiece assembly for providing air to the millipore vaporizer element, the E-liquid siphoned on the millipore vaporizer element is heated by the millipore vaporizer element to generate the E-liquid vapor and the E-liquid vapor generated exits through the mouthpiece assembly to the user.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment. The drawings do not limit the present disclosure to the specific embodiments disclosed and described herein. The drawings are not necessarily to scale, emphasis instead being placed upon clearly illustrating the principles of the disclosure, and wherein:

FIG. 1 is a perspective external view of an exemplary electronic cigarette having millipore vaporizer assembly according to certain embodiments of the present disclosure;

FIG. 2 is a perspective external view of a millipore vaporizer assembly according to certain embodiments of the present disclosure;

FIG. 3 is a side view of the millipore vaporizer assembly according to certain embodiments of the present disclosure;

FIG. 4 is a top view of the millipore vaporizer assembly according to certain embodiments of the present disclosure;

FIG. 5 is a bottom view of the millipore vaporizer assembly according to certain embodiments of the present disclosure;

FIG. 6 is an exploded perspective view of the millipore vaporizer assembly according to certain embodiments of the present disclosure;

FIG. 7 is a sectional view of the millipore vaporizer assembly showing air flow according to certain embodiments of the present disclosure; and

FIG. 8 is a flow chart of an exemplary method of using the electronic cigarette having the millipore vaporizer assembly according to certain embodiments of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

Many specific details are provided in the following descriptions to make the present disclosure be fully understood, but the present disclosure may also be implemented by using other manners different from those described herein, so that the present disclosure is not limited by the specific embodiments disclosed in the following.

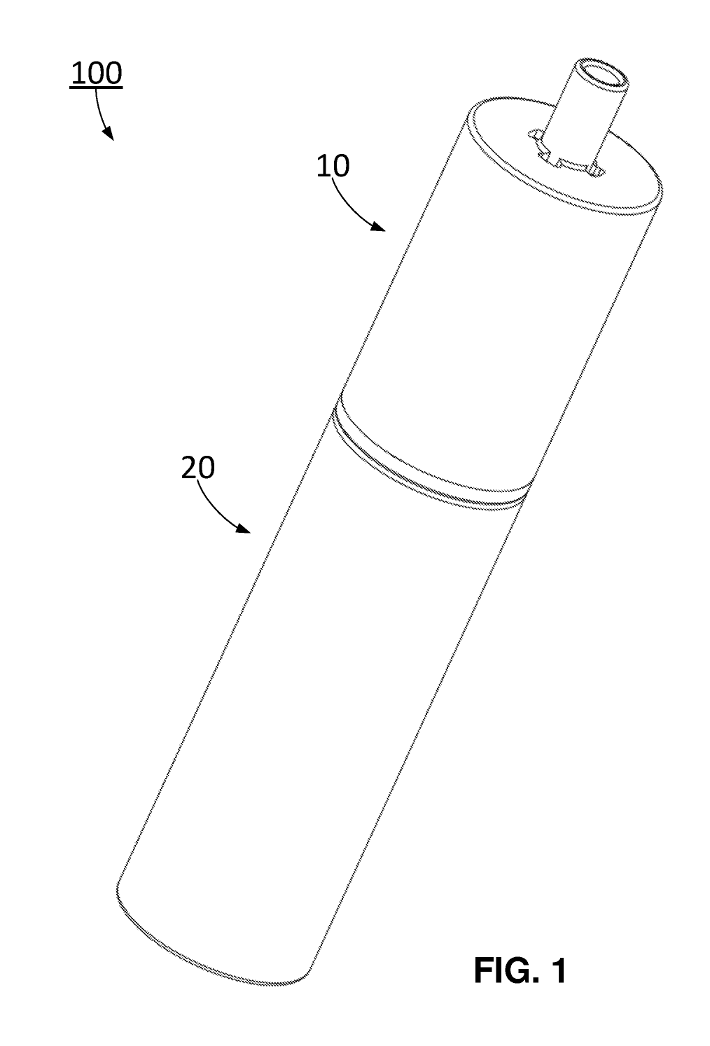

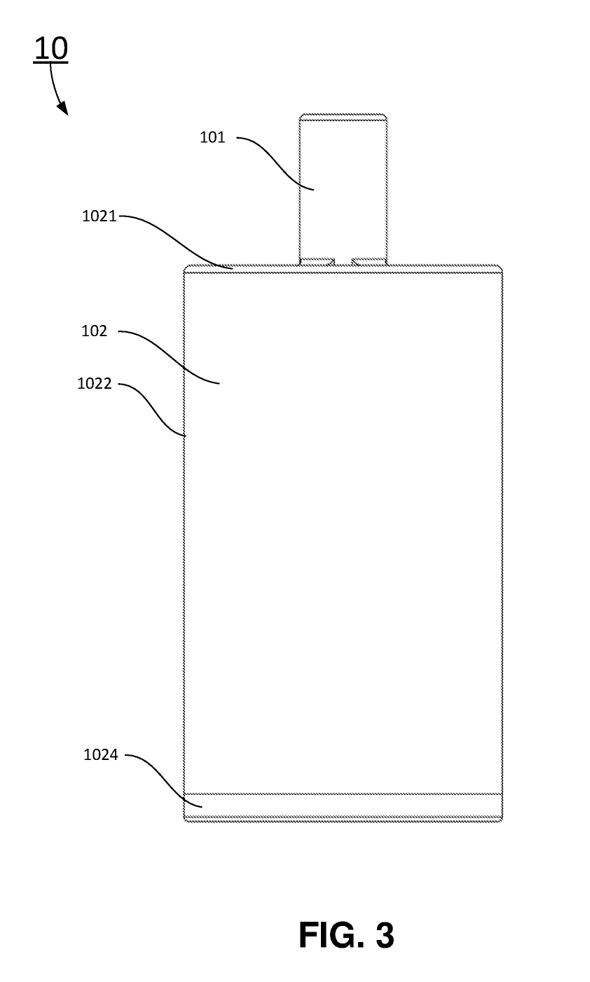

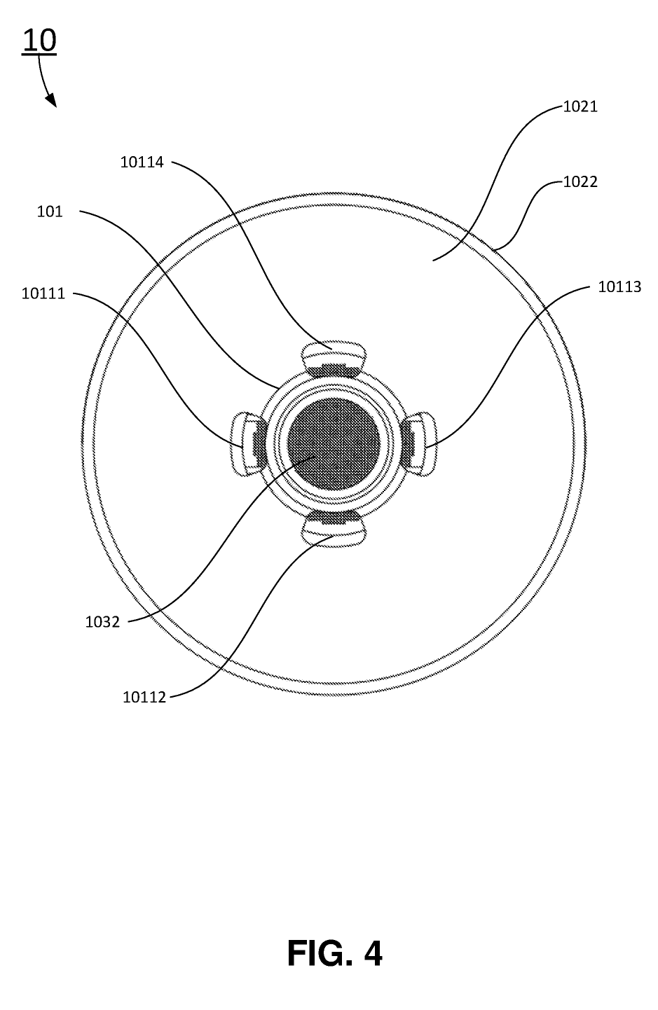

The description will be made as to the embodiments of the present disclosure in conjunction with the accompanying drawings FIGS. 1 through 8.

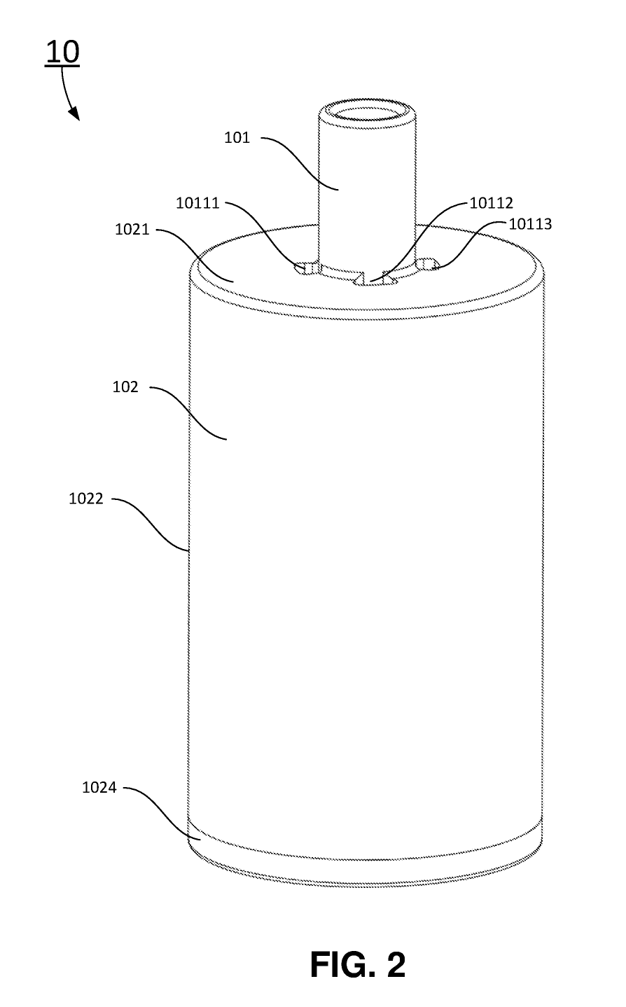

Referring now to FIGS. 2-7, in one aspect, the present disclosure relates to a millipore vaporizer assembly 10. In certain embodiments, the millipore vaporizer assembly 10 includes: a mouthpiece assembly 101 for a user to enjoy vaporized E-liquid, an E-liquid storage tank assembly 102 for storing E-liquid 1025, and a millipore vaporizer element 1032 for generating the vaporized E-liquid. The millipore vaporizer element 1032 is positioned on a millipore vaporizer element support 1035, and the millipore vaporizer element 1032 is used for receiving and heating the E-liquid 1025 from the E-liquid storage tank assembly 102 to generate the vaporized E-liquid. The millipore vaporizer element 1032 has a first electric terminal 1033 and a second electric terminal 1034. When the user connects the first electric terminal 1033 and the second electric terminal 1034 to an electrical power supply assembly 20, the millipore vaporizer element 1032 receives the E-liquid 1025 from the E-liquid storage tank assembly 102 and heats the E-liquid 1025 received through the millipore vaporizer element 1032 to generate the vaporized E-liquid.

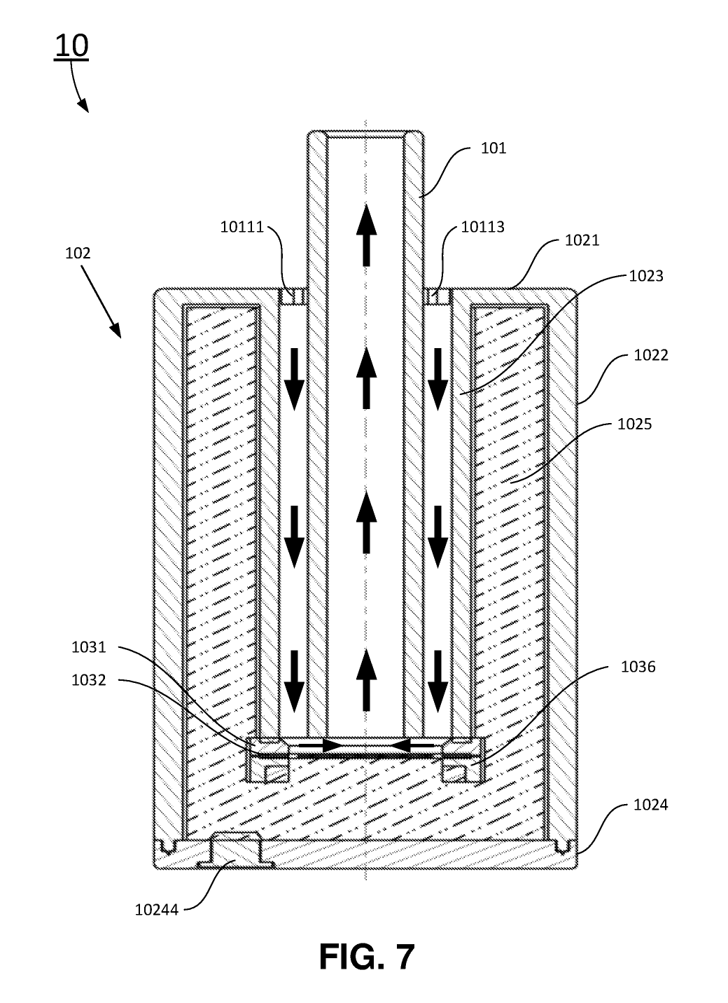

In certain embodiments, the millipore vaporizer assembly 10 defines certain number of air intake openings 1011. These air intake openings 1011 are evenly distributed outside of the mouthpiece assembly 101 for providing outside air to the millipore vaporizer element 1032. As shown in FIGS. 2, 4, and 6, in one embodiment, the air intake openings 1011 include a first air intake opening 10111, a second air intake opening 10112, a third air intake opening 10113, and a fourth air intake opening 10114. As shown in FIG. 7, outside air enters the millipore vaporizer assembly 10 through the air intake openings 1011, goes down to the millipore vaporizer element 1032, and exits the millipore vaporizer assembly 10 through the mouthpiece 101.

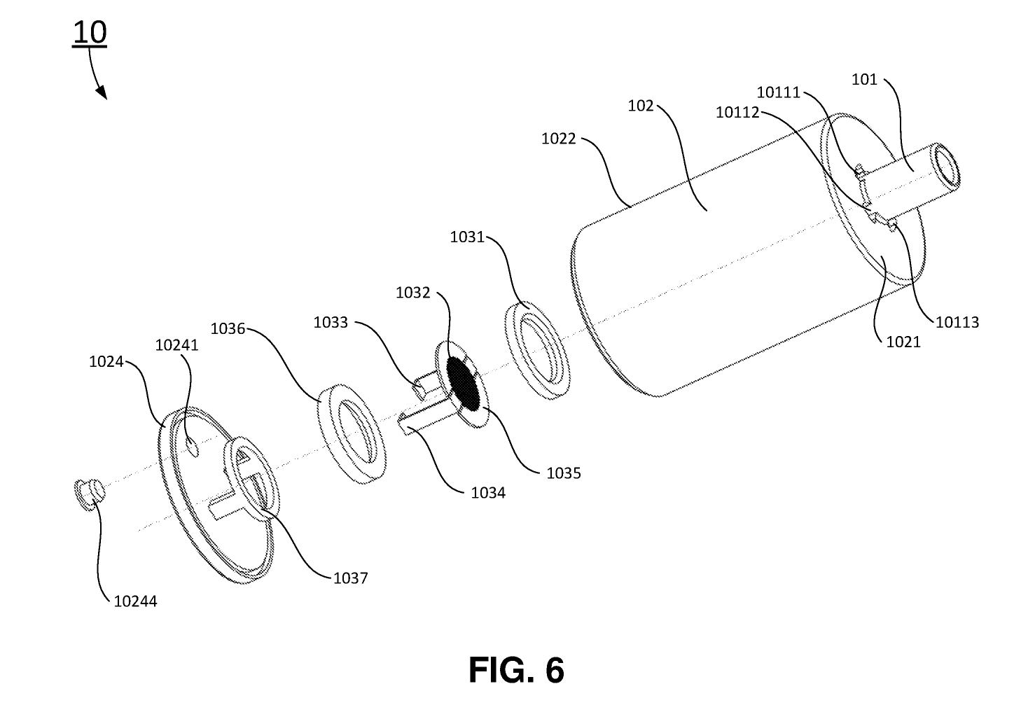

In certain embodiments, the millipore vaporizer element 1032 has: a first side and an opposite, second side. As shown in FIG. 6, the first side faces those air intake openings 1011 for receiving outside air through these air intake openings 1011. The second side is in direct contact with the E-liquid 1025 inside the E-liquid storage tank assembly 102 for siphoning and heating the E-liquid 1025. In certain embodiments, the first side of the millipore vaporizer element 1032 is sealed by a first sealing ring 1031, and the second side of the millipore vaporizer element 1032 is sealed by a second sealing ring 1036. The millipore vaporizer element 1032 has many pores. In one embodiment, the diameter of these pores ranges between 2 nanometers to 500 nanometers. The sizes of these pores determine the speed of the E-liquid 1025 flowing through from the E-liquid storage tank assembly 102 to the millipore vaporizer element 1032, and amount of vaporized E-liquid generated by the millipore vaporizer assembly 10. The bigger the sizes of these pores, the faster the E-liquid 1025 flowing through from the E-liquid storage tank assembly 102 to the millipore vaporizer element 1032, and bigger the amount of vaporized E-liquid generated by the millipore vaporizer assembly 10.

In certain embodiments, the millipore vaporizer element 1032 is made of one or more resistive materials. When the millipore vaporizer element 1032 is powered by the electrical power supply assembly 20 through the first electric terminal 1033 and the second electric terminal 1034, the millipore vaporizer element 1032 heats the E-liquid 1025 siphoned through those pores to generate the vaporized E-liquid. The millipore vaporizer element 1032 may include: a grid shaped heating element, a mesh shaped heating element, a net shaped heating element, a spiral heating element; and any combination these heating elements. The heating element is surrounded with millipore materials such that the E-liquid 1025 in the E-liquid storage tank assembly 102 may be siphoned through the millipore materials and heated by the heating element. When the millipore vaporizer element 1032 is powered by the electrical power supply assembly 20, the millipore vaporizer element 1032 heats the E-liquid 1025 siphoned through those pores to generate the vaporized E-liquid.

In certain embodiments, the heating element may be made with one or more of: aluminum (Al), Chromium (Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium (Cd), Tantalum (Ta), Tungsten (W), Iridium (Ir), Platinum (Pt), Gold (Au), and alloys of these materials.

As shown in FIGS. 6 and 7, in certain embodiments, the E-liquid storage tank assembly 102 includes: an E-liquid storage tank top cover 1021, an E-liquid storage tank external wall 1022, an E-liquid storage tank internal wall 1023, and an E-liquid storage tank bottom cover 1024. The E-liquid storage tank external wall 1022 may be made of transparent materials such that remaining E-liquid level may be shown to a user. In certain embodiments, the transparent materials may include: plastics, acrylics, and glass.

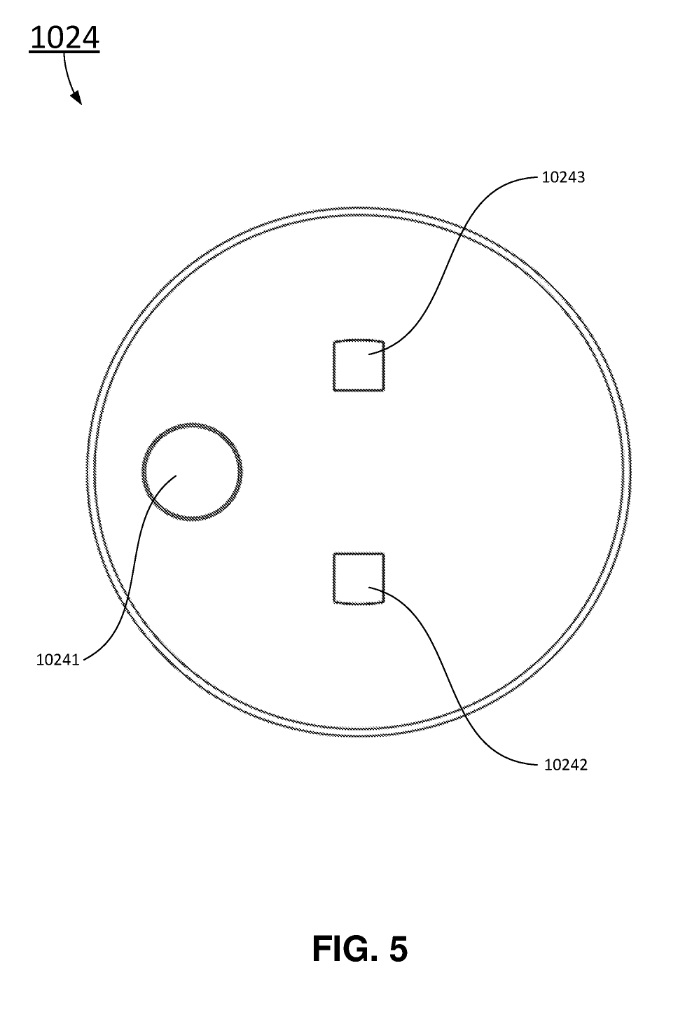

In certain embodiments, the E-liquid storage tank bottom cover 1024 defines a refilling opening 10241 for refilling the E-liquid into the E-liquid storage tank assembly 102, as shown in FIG. 6. As shown in FIGS. 5 and 6, the E-liquid storage tank bottom cover 1024 includes: a first external electric terminal 10242 for electrically connecting a first terminal of the electrical power supply assembly 20 to the first electric terminal 1033, a second external electric terminal 10243 for electrically connecting a second terminal of the electrical power supply assembly 20 to the second electric terminal 1034, a millipore vaporizer assembly support 1037 for installing the millipore vaporizer element support 1035 and connecting the millipore vaporizer element 1032 to the first external electric terminal 10242 and the second external electric terminal 10243, and a refilling opening plug 10244 to prevent the E-liquid 1025 from leaking out after refilling.

Referring now to FIGS. 1-7, in another aspect, the present disclosure relates to an electronic cigarette 100. In certain embodiments, the electronic cigarette 100 includes a millipore vaporizer assembly 10 and an electrical power supply assembly 20. The millipore vaporizer assembly 10 includes: a mouthpiece assembly 101 for a user to enjoy vaporized E-liquid, an E-liquid storage tank assembly 102 for storing E-liquid 1025, and a millipore vaporizer element 1032 for generating the vaporized E-liquid. The millipore vaporizer element 1032 is positioned on a millipore vaporizer element support 1035, and the millipore vaporizer element 1032 is used for receiving and heating the E-liquid 1025 from the E-liquid storage tank assembly 102 to generate the vaporized E-liquid. The millipore vaporizer element 1032 has a first electric terminal 1033 and a second electric terminal 1034. When the user connects the first electric terminal 1033 and the second electric terminal 1034 to an electrical power supply assembly 20, the millipore vaporizer element 1032 receives the E-liquid 1025 from the E-liquid storage tank assembly 102 and heats the E-liquid 1025 received through the millipore vaporizer element 1032 to generate the vaporized E-liquid.

In certain embodiments, the millipore vaporizer assembly 10 defines certain number of air intake openings 1011. These air intake openings 1011 are evenly distributed outside of the mouthpiece assembly 101 for providing outside air to the millipore vaporizer element 1032. As shown in FIGS. 2, 4, and 6, in one embodiment, the air intake openings 1011 include a first air intake opening 10111, a second air intake opening 10112, a third air intake opening 10113, and a fourth air intake opening 10114. As shown in FIG. 7, outside air enters the millipore vaporizer assembly 10 through the air intake openings 1011, goes down to the millipore vaporizer element 1032, and exits the millipore vaporizer assembly 10 through the mouthpiece 101.

In certain embodiments, the millipore vaporizer element 1032 has: a first side and an opposite, second side. As shown in FIG. 6, the first side faces those air intake openings 1011 for receiving outside air through these air intake openings 1011. The second side is in direct contact with the E-liquid 1025 inside the E-liquid storage tank assembly 102 for siphoning and heating the E-liquid 1025. In certain embodiments, the first side of the millipore vaporizer element 1032 is sealed by a first sealing ring 1031, and the second side of the millipore vaporizer element 1032 is sealed by a second sealing ring 1036. The millipore vaporizer element 1032 has many pores. In one embodiment, the diameter of these pores ranges between 2 nanometers to 500 nanometers. The sizes of these determines the speed of the E-liquid 1025 flowing through from the E-liquid storage tank assembly 102 to the millipore vaporizer element 1032, and amount of vaporized E-liquid generated by the millipore vaporizer assembly 10. The bigger the sizes of these pores, the faster the E-liquid 1025 flowing through from the E-liquid storage tank assembly 102 to the millipore vaporizer element 1032, and bigger the amount of vaporized E-liquid generated by the millipore vaporizer assembly 10.

In certain embodiments, the millipore vaporizer element 1032 is made of one or more resistive materials. When the millipore vaporizer element 1032 is powered by the electrical power supply assembly 20 through the first electric terminal 1033 and the second electric terminal 1034, the millipore vaporizer element 1032 heats the E-liquid 1025 siphoned through those pores to generate the vaporized E-liquid. The millipore vaporizer element 1032 may include: a grid shaped heating element, a mesh shaped heating element, a net shaped heating element, a spiral heating element; and any combination these heating elements. The heating element is surrounded with millipore materials such that the E-liquid 1025 in the E-liquid storage tank assembly 102 may be siphoned through the millipore materials and heated by the heating element. When the millipore vaporizer element 1032 is powered by the electrical power supply assembly 20, the millipore vaporizer element 1032 heats the E-liquid 1025 siphoned through those pores to generate the vaporized E-liquid.

In certain embodiments, the heating element may be made with one or more of: aluminum (Al), Chromium (Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium (Cd), Tantalum (Ta), Tungsten (W), Iridium (Jr), Platinum (Pt), Gold (Au), and alloys of these materials.

In certain embodiments, the electrical power supply assembly 20 includes: an electrical power source (not shown in FIGS. 1-7), and an electrical power connector (not shown in FIGS. 1-7). A person skilled in the art should appreciate the fact that these elements are essential to the electrical power supply assembly 20, and it does not require detailed illustration and explanation. The electrical power source may include a battery and/or a rechargeable battery. In certain embodiments, the rechargeable battery may include including lead-acid, nickel cadmium (NiCd), nickel metal hydride (NiMH), lithium ion (Li-ion), and lithium ion polymer (Li-ion polymer).

The electrical power connector includes a first power terminal and a second power terminal. The electrical power supply assembly 20 is connected to the electronic cigarette 100 through the electrical power connector to provide electrical power supply to the millipore vaporizer assembly 10. In certain embodiments, the electrical power connector may be a T-shaped groove connector, a dovetail shaped slot connector, a magnetic attachment connector, a threaded connector, and a multi-threaded connector.

As shown in FIGS. 6 and 7, in certain embodiments, the E-liquid storage tank assembly 102 includes: an E-liquid storage tank top cover 1021, an E-liquid storage tank external wall 1022, an E-liquid storage tank internal wall 1023, and an E-liquid storage tank bottom cover 1024. The E-liquid storage tank external wall 1022 may be made of transparent materials such that remaining E-liquid level may be shown to a user. In certain embodiments, the transparent materials may include: plastics, acrylics, and glass.

In certain embodiments, the E-liquid storage tank bottom cover 1024 defines a refilling opening 10241 for refilling the E-liquid into the E-liquid storage tank assembly 102, as shown in FIG. 6. As shown in FIGS. 5 and 6, the E-liquid storage tank bottom cover 1024 includes: a first external electric terminal 10242 for electrically connecting a first terminal of the electrical power supply assembly 20 to the first electric terminal 1033, a second external electric terminal 10243 for electrically connecting a second terminal of the electrical power supply assembly 20 to the second electric terminal 1034, a millipore vaporizer assembly support 1037 for installing the millipore vaporizer element support 1035 and connecting the millipore vaporizer element 1032 to the first external electric terminal 10242 and the second external electric terminal 10243, and a refilling opening plug 10244 to prevent the E-liquid 1025 from leaking out after refilling.

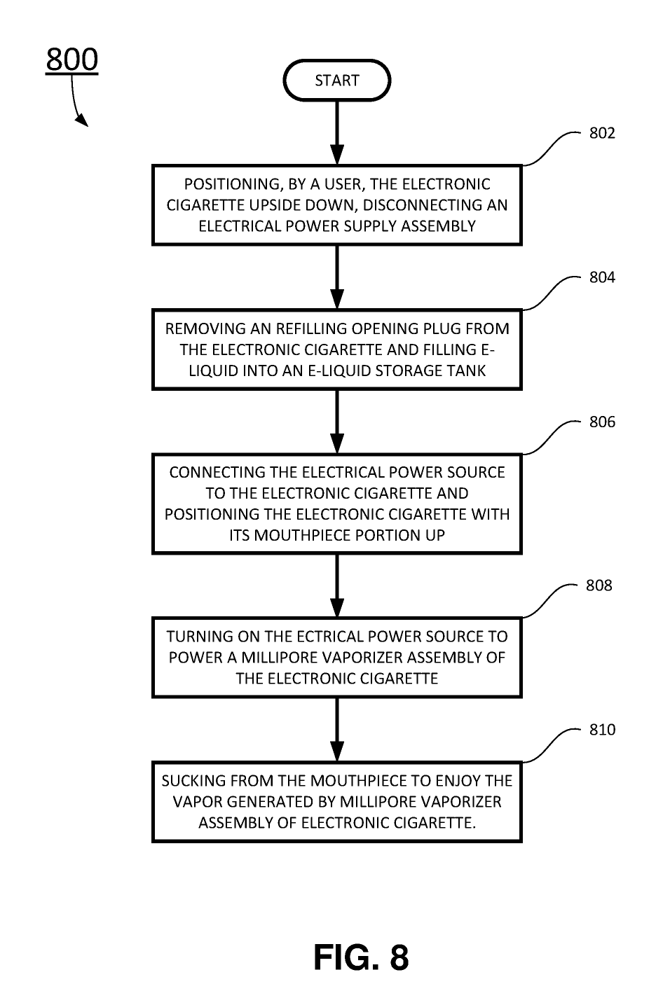

In yet another aspect, the present disclosure relates to method 800 of using an electronic cigarette 100 having a millipore vaporizer assembly 10 as shown in FIG. 8.

At block 802, a user positions the electronic cigarette 100 upside down, and removes and disconnects an electrical power supply assembly 20 from the electronic cigarette 100.

At block 804, the user may remove a refilling opening plug 10244 from the electronic cigarette 100, and fill E-liquid 1025 into an E-liquid storage tank assembly 102. The electronic cigarette 100 remains upside down to prevent the E-liquid 1025 from leaking out after the E-liquid filling.

At block 806, the user installs and connects the electrical power supply assembly 20 to the electronic cigarette 100. The user may also flip over the electronic cigarette 100 to with its mouthpiece side up to allow the E-liquid 1025 in the E-liquid storage tank assembly 102 to soak into a millipore vaporizer element 1032.

At block 808, the user turns on the electrical power supply assembly 20 to power the millipore vaporizer element 1032 and to vaporize the E-liquid 1025 siphoned through the millipore vaporizer element 1032.

At block 810, the user sucks vaporized E-liquid from the millipore vaporizer assembly 10 through a mouthpiece assembly 101. Air outside of the electronic cigarette 100 enters the millipore vaporizer assembly 10 through several air intake openings 1011 defined and evenly distributed outside of the mouthpiece assembly 101 for providing air to the millipore vaporizer element 1032. The E-liquid 1025 siphoned on the millipore vaporizer element 1032 is heated by the millipore vaporizer element 1032 to generate the E-liquid vapor and the E-liquid vapor generated exits through the mouthpiece assembly 101 to the user.

In certain embodiments, the method 800 may also include: connecting, by the user, a first electric terminal and a second electric terminal of the electrical power supply assembly 20 to a first external electric terminal 10242 and a second external electric terminal 10243 of the electronic cigarette 100, respectively. The electrical power supply assembly 20 may include a battery, and/or a rechargeable battery. In certain embodiments, the rechargeable battery may include including lead-acid, nickel cadmium (NiCd), nickel metal hydride (NiMH), lithium ion (Li-ion), and lithium ion polymer (Li-ion polymer). The electrical power supply assembly 20 is connected to the electronic cigarette 100 through one of: a T-shaped groove connector, a dovetail shaped slot connector, a magnetic attachment connector, a threaded connector, and a multi-threaded connector. In certain embodiments, the method 800 may also include: removing, by the user, the electrical power supply assembly 20 from the electronic cigarette 100 for replacement when the battery is not rechargeable, or recharging when the battery is rechargeable.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims, the foregoing description and the exemplary embodiments described therein, and accompanying drawings.

What is claimed is:

1. A millipore vaporizer assembly, comprising:
a mouthpiece assembly for a user to enjoy vaporized E-liquid;
an E-liquid storage tank assembly for storing E-liquid; and
a millipore vaporizer element positioned on a millipore vaporizer element support,
wherein the millipore vaporizer element comprises a first electric terminal and a second electric terminal, and when the user connects the first electric terminal and the second electric terminal to an electrical power supply assembly, the millipore vaporizer element receives the E-liquid from the E-liquid storage tank assembly and heats the E-liquid received through the millipore vaporizer element to generate the vaporized E-liquid.

2. The millipore vaporizer assembly of claim 1, wherein the millipore vaporizer assembly defines a plurality of air intake openings, wherein the plurality of air intake openings is evenly distributed outside of the mouthpiece assembly for providing outside air to the millipore vaporizer element.

3. The millipore vaporizer assembly of claim 1, wherein the millipore vaporizer element comprises:
a first side facing the plurality of air intake openings for receiving outside air through the plurality of air intake openings; and
an opposite, second side in direct contact with the E-liquid inside the E-liquid storage tank assembly for siphoning and heating the E-liquid,
wherein the first side of the millipore vaporizer element is sealed by a first sealing ring, and the second side of the millipore vaporizer element is sealed by a second sealing ring.

4. The millipore vaporizer assembly of claim 1, wherein the millipore vaporizer element comprises a plurality of pores, wherein the diameter of the plurality of the pores ranges between 2 nanometers to 500 nanometers.

5. The millipore vaporizer assembly of claim 4, wherein the millipore vaporizer element comprises one or more resistive materials, when the millipore vaporizer element is powered by the electrical power supply assembly through the first electric terminal and the second electric terminal, the millipore vaporizer element heats the E-liquid siphoned through the plurality of pores to generate the vaporized E-liquid.

6. The millipore vaporizer assembly of claim 1, wherein the millipore vaporizer element comprises:
a grid shaped heating element;
a mesh shaped heating element;
a net shaped heating element;
a spiral heating element; and
any combination thereof,
wherein the heating element is surrounded with millipore materials such that the E-liquid in the E-liquid storage tank assembly may be siphoned through the millipore materials and heated by the heating element, when the millipore vaporizer element is powered by the electrical power supply assembly, the millipore vaporizer element heats the E-liquid siphoned through the plurality of pores to generate the vaporized E-liquid.

7. The millipore vaporizer assembly of claim 1, wherein the E-liquid storage tank assembly comprises:
an E-liquid storage tank top cover;
an E-liquid storage tank external wall;
an E-liquid storage tank internal wall; and
an E-liquid storage tank bottom cover.

8. The millipore vaporizer assembly of claim 7, wherein the E-liquid storage tank external wall comprises transparent materials such that remaining E-liquid level may be shown to a user, wherein the transparent materials comprise: plastics, acrylics, and glass.

9. The millipore vaporizer assembly of claim 7, wherein the E-liquid storage tank bottom cover defines a refilling opening for refilling the E-liquid into the E-liquid storage tank assembly, and the E-liquid storage tank bottom cover comprises:
a first external electric terminal for electrically connecting a first terminal of the electrical power supply assembly to the first electric terminal;
a second external electric terminal for electrically connecting a second terminal of the electrical power supply assembly to the second electric terminal; and
a refilling opening plug to prevent the E-liquid from leaking out after refilling.

10. An electronic cigarette, comprising:
a millipore vaporizer assembly, wherein the millipore vaporizer assembly comprises:
a mouthpiece assembly for a user to enjoy vaporized E-liquid;
an E-liquid storage tank assembly for storing E-liquid; and
a millipore vaporizer element positioned on a millipore vaporizer element support; and
an electrical power supply assembly having an electrical power source and an electrical power connector, wherein the electrical power connector comprises a first power terminal and a second power terminal to provide electrical power supply from the electrical power source to the millipore vaporizer element,
wherein the millipore vaporizer element comprises a first electric terminal and a second electric terminal, and when the user connects the first electric terminal and the second electric terminal to the electrical power supply assembly, the millipore vaporizer element receives the E-liquid from the E-liquid storage tank assembly and heats the E-liquid received through the millipore vaporizer element to generate the vaporized E-liquid.

11. The electronic cigarette of claim 10, wherein the millipore vaporizer assembly 10 defines a plurality of air intake openings, wherein the plurality of air intake openings is evenly distributed outside of the mouthpiece assembly for providing outside air to the millipore vaporizer element.

12. The electronic cigarette of claim 11, wherein the millipore vaporizer element comprises:
a first side facing the plurality of air intake openings receiving outside air through the plurality of air intake openings; and
an opposite, second side facing the E-liquid inside the E-liquid storage tank assembly for siphoning and heating the E-liquid, wherein the first side of the millipore vaporizer element is sealed by a first sealing ring, and the second side of the millipore vaporizer element is sealed by a second sealing ring.

13. The electronic cigarette of claim 10, wherein the millipore vaporizer element comprises a plurality of pores, and one or more resistive materials, when the millipore vaporizer element is powered by the electrical power supply assembly through the first electric terminal and the second electric terminal, the millipore vaporizer element heats the E-liquid siphoned through the plurality of pores to generate the vaporized E-liquid.

14. The electronic cigarette of claim 10, wherein the millipore vaporizer element comprises:
a grid shaped heating element;
a mesh shaped heating element;
a net shaped heating element;
a spiral heating element; and
any combination thereof, wherein the heating element is surrounded with millipore materials such that the E-liquid in the E-liquid storage tank assembly may be siphoned through the millipore materials and heated by the heating element, when the millipore vaporizer element is powered by the electrical power supply assembly, the millipore vaporizer element heats the E-liquid siphoned through the plurality of pores to generate the vaporized E-liquid.

15. The electronic cigarette of claim 10, wherein the electrical power supply assembly comprises:
an electrical power source; and
an electrical power connector having a first power terminal and a second power terminal,
wherein the electrical power source comprises a battery and a rechargeable battery, and the electrical power supply assembly is connected to the electronic cigarette through the electrical power connector to provide electrical power supply to the millipore vaporizer assembly.

16. The electronic cigarette of claim 10, wherein the E-liquid storage tank assembly comprises:
an E-liquid storage tank top cover;
an E-liquid storage tank external wall;
an E-liquid storage tank internal wall; and
an E-liquid storage tank bottom cover.

17. The electronic cigarette of claim 16, wherein the E-liquid storage tank external wall comprises transparent materials such that remaining E-liquid level may be shown to a user, wherein the transparent materials comprise: plastics, acrylics, and glass.

18. The electronic cigarette of claim 16, wherein the E-liquid storage tank bottom cover defines a refilling opening for refilling the E-liquid into the E-liquid storage tank assembly, and the E-liquid storage tank bottom cover comprises:
a first external electric terminal for electrically connecting a first terminal of the electrical power supply assembly to the first electric terminal;
a second external electric terminal for electrically connecting a second terminal of the electrical power supply assembly to the second electric terminal; and
a refilling opening plug to prevent the E-liquid from leaking out after refilling.

19. A method of using an electronic cigarette having a millipore vaporizer assembly, comprising:
positioning, by a user, the electronic cigarette upside down, and disconnecting an electrical power supply assembly from the electronic cigarette;
removing a refilling opening plug from the electronic cigarette, filling E-liquid into an E-liquid storage tank assembly and putting the refilling opening plug back after the filling;
connecting, by the user, the electrical power supply assembly to the electronic cigarette and positioning the electronic cigarette mouthpiece side up to allow the E-liquid in the E-liquid storage tank assembly to soak into a millipore vaporizer element; and
turning, by the user, on the electrical power supply assembly to provide electrical power to the millipore vaporizer assembly; and
sucking E-liquid vapor from the millipore vaporizer assembly through a mouthpiece assembly, wherein air outside of the electronic cigarette enters the millipore vaporizer assembly through a plurality of air intake openings defined and evenly distributed outside of the mouthpiece assembly for providing air to the millipore vaporizer element, the E-liquid siphoned on the millipore vaporizer element is heated by the millipore vaporizer element to generate the E-liquid vapor and the E-liquid vapor generated exits through the mouthpiece assembly to the user.

20. The method of claim 19, further comprising one or more of:
connecting, by the user, a first external power terminal and a second external power terminal of the electrical power supply assembly to a first terminal and a second terminal of the millipore vaporizer element through an electrical power connector, wherein the electrical power connector comprises:
a T-shaped groove connector;
a dovetail shaped slot connector;
a magnetic attachment connector;
a threaded connector; and
a multi-threaded connector; and
removing, by the user, the electrical power supply assembly from the electronic cigarette for replacement or recharging.
